(19) United States
(12) Patent Application Publication
(10) Pub. No.: US 2026/0081413 A1
(43) Pub. Date: Mar. 19, 2026

(54) ELECTRICAL ISOLATOR SYSTEM

(71) Applicant: Preformed Line Products Company, Cleveland, OH (US)

(72) Inventors: Douglas Bell, Solon, OH (US); Benjamin Ciesielczyk, Madison, OH (US); Nicholas Lees, Lakewood, OH (US); Jacob Palmer, Chesterland, OH (US); Justin Perl, Cleveland, OH (US)

(21) Appl. No.: 19/333,554

(22) Filed: Sep. 19, 2025

Related U.S. Application Data
(60) Provisional application No. 63/696,805, filed on Sep. 19, 2024.

(51) Int. Cl. H02G 15/02; H01R 24/54; H02G 15/007; H02G 15/04

(52) U.S. Cl. CPC H02G 15/025; H01R 24/542; H02G 15/007; H02G 15/046

(57) ABSTRACT

An isolator includes an isolator body that defines a first through hole extended from a distal isolator end portion to a proximal isolator end portion in a longitudinal direction of the isolator body. The isolator also includes a grommet supported on the isolator body at the distal isolator end portion, wherein the grommet defines a second through hole that overlaps the first through hole in the longitudinal direction. The isolator also includes a cap that engages the distal isolator end portion in the longitudinal direction, across the grommet, where the cap presses the grommet toward the isolator body, into the first through hole, reducing a width of the second through hole in a lateral direction orthogonal to the longitudinal direction.

### CROSS REFERENCE TO RELATED APPLICATIONS

The application claims priority to and the benefit of U.S. Provisional Patent Application No. 63/696,805, filed on Sep. 19, 2024, entitled “Electrical Isolator System”, which we incorporate by reference in its entirety.

### BACKGROUND

Optical ground wire (OPGW) cables are often critical components in modern power transmission systems, combining grounding and communication functions. These cables, typically installed on transmission towers, are exposed to harsh environmental conditions, including rain, dust, wind, and other forms of debris. To ensure the long-term functionality and reliability of OPGW cables, they are often used in conjunction with electrical isolators, which prevent the transmission of electrical faults from the tower to the ground wire while protecting the cable from environmental damage.

Conventional electrical isolators for OPGW cables often suffer from several shortcomings. First, they may not provide adequate sealing against water, dust, and debris, leading to potential ingress that can compromise the performance of the isolator and the cable. Ingress of moisture and contaminants can lead to corrosion, short circuits, and eventual failure of the isolator, necessitating costly maintenance and repairs.

Second, many existing isolators are not designed to securely hold the OPGW cable, which can lead to movement of the cable within the isolator. This movement may cause the jacket of the cable to abrade against internal components, resulting in wear and damage to both the cable and the isolator. This can further lead to electrical faults or failures, compromising the integrity of the entire system.

Moreover, traditional isolators often consist of multiple components that require complex assembly and installation processes. The high number of parts increases the likelihood of assembly errors, extends installation time, and raises overall costs. Additionally, the complexity of these isolators can make field repairs difficult and time-consuming.

### BRIEF DESCRIPTION

According to one aspect, an isolator includes an isolator body that defines a first through hole extended from a distal isolator end portion to a proximal isolator end portion in a longitudinal direction of the isolator body. The isolator also includes a grommet supported on the isolator body at the distal isolator end portion, where the grommet defines a second through hole that overlaps the first through hole in the longitudinal direction. The isolator also includes a cap that engages the distal isolator end portion in the longitudinal direction, across the grommet, where the cap presses the grommet toward the isolator body and reduces a width of the second through hole defined by the grommet perpendicular to the longitudinal direction.

According to another aspect, an isolator includes an isolator body that defines a first through hole extended from a distal isolator end portion to a proximal isolator end portion in a longitudinal direction of the isolator body. The isolator body includes a shed extended outward from the distal isolator end portion or the proximal isolator end portion perpendicular to the longitudinal direction. The isolator also includes an insert supported on the isolator body. The insert includes an insert wall that extends along the first through hole in the longitudinal direction from the distal isolator end portion toward the proximal isolator end portion. The insert also includes a retention mechanism that obstructs movement of a cable element inserted into the isolator body.

According to another aspect, an isolator includes an isolator body that defines a first through hole extended from a distal isolator end portion to a proximal isolator end portion in a longitudinal direction of the isolator body. The isolator also includes a grommet supported on the isolator body at the distal isolator end portion, wherein the grommet defines a second through hole that overlaps the first through hole in the longitudinal direction. The isolator also includes a cap that engages the distal isolator end portion in the longitudinal direction, across the grommet, where the cap presses the grommet toward the isolator body, into the first through hole, reducing a width of the second through hole in a lateral direction orthogonal to the longitudinal direction.

According to another aspect, an isolator includes an isolator body that defines a first through hole extended from a distal isolator end portion to a proximal isolator end portion in a longitudinal direction of the isolator body. The isolator body includes a shed extended outward from the distal isolator end portion or the proximal isolator end portion in a lateral direction orthogonal to the longitudinal direction, and includes a seat surface disposed around the first through hole. The isolator also includes a grommet inserted in the first through hole. The grommet defines a second through hole in the isolator body, and pressing the grommet into the first through hole against the seat surface in the longitudinal direction reduces a width of the second through hole in a lateral direction orthogonal to the longitudinal direction.

According to another aspect, an adapter including a sleeve with a wall that defines an interior in a lateral direction. The adapter also includes an obstruction mechanism that is located within the interior and includes a platform extended in a longitudinal direction perpendicular to the lateral direction and a ramp extended from the platform toward the wall in the lateral direction and the longitudinal direction. The adapter also includes a height adjustment mechanism that is supported within the interior by the platform. The adapter also includes a plate extended in the longitudinal direction, and a fastener fixed with the plate and the platform, where the fastener supports the plate a distance from the platform in the lateral direction.

According to another aspect, an adapter includes a sleeve with a wall that defines an interior in a lateral direction. The adapter also includes a platform extended in the longitudinal direction and a height adjustment mechanism that is supported within the interior, on the platform. The height adjustment mechanism includes a plate extended in the longitudinal direction, and a fastener fixed with the plate and the platform. The fastener supports the plate a distance from the platform in the lateral direction, and rotating the fastener relative to the platform drives the plate in the lateral direction relative to the wall.

According to another aspect, an adapter includes a sleeve having a wall that defines an interior in a lateral direction. The adapter also includes an obstruction mechanism that is located within the interior. The obstruction mechanism includes a platform extended in a longitudinal direction perpendicular to the lateral direction. The obstruction mechanism also includes a ramp extended from the platform toward the wall in the lateral direction and the longitudinal direction. The adapter also includes a plate fixed with the platform and extended in the longitudinal direction, where the plate faces a side of the wall opposite the platform in the lateral direction.

According to another aspect, an adapter includes a sleeve including a wall that defines an interior in a lateral direction and a normal direction orthogonal to the lateral direction. The adapter also includes an obstruction mechanism that is located within the interior. The obstruction mechanism includes a platform extended in a longitudinal direction orthogonal to the lateral direction and the normal direction. The obstruction mechanism also includes a ramp extended from the platform toward the wall in the normal direction and the longitudinal direction. The obstruction mechanism also includes a plate extended in the longitudinal direction along the platform. The obstruction mechanism also includes a fastener that fixes the plate to the platform in the normal direction.

According to another aspect, an adapter includes a sleeve including a wall that defines an interior in a lateral direction and a normal direction orthogonal to the lateral direction. The adapter also includes a platform disposed within the interior, extended in the lateral direction, and extended in a longitudinal direction orthogonal to the lateral direction and the normal direction. The adapter also includes a plate extended in the longitudinal direction and the lateral direction, wherein the plate is disposed in the interior and overlaps the platform in the normal direction. The adapter also includes a fastener that fixes the plate with the platform, wherein the fastener continuously presses the plate toward the platform in the normal direction.

The innovation described herein describes an electrical isolator system that offers effective sealing protection from environmental conditions, and ease of installation and removal. In addition to other described features, functions, and benefits, the isolator described herein can enable securely and efficiently fastening a cable of a variety of types and sizes for protecting and isolating conductors in the cable.

### BRIEF DESCRIPTION OF THE DRAWINGS

FIG. 1 is a perspective view of an example cable assembly including an isolator, partially assembled, and a cable in accordance with aspects of the innovation.

FIG. 2 is a perspective view of the isolator of FIG. 1.

FIG. 3 is an exploded view of the isolator of FIG. 1.

FIG. 4 is a cross-sectional side view of the isolator of FIG. 1.

FIG. 5 is a partial cross-sectional side view of the isolator of FIG. 1, including a cap on a distal isolator end portion.

FIG. 6 is a partial perspective cross-sectional view of an example isolator in accordance with aspects of the innovation.

FIG. 7 is a partial perspective view of the isolator of FIG. 6.

FIG. 8 is a cross-sectional side view of the isolator of FIG. 1, including an adapter on a distal isolator end portion.

FIG. 9 is a partial perspective view of the adapter.

FIG. 10 is a perspective view of an isolator including a cap in accordance with aspects of the innovation.

FIG. 11 is a cross-sectional side view of a cable assembly including the isolator including the cap of FIG. 10.

FIG. 12 is a top view of the isolator including the cap of FIG. 10.

FIG. 13 is a bottom view of the isolator including the cap of FIG. 10.

FIG. 14 is a side view of the isolator including the cap of FIG. 10.

FIG. 15 is an exploded perspective view of an isolator including an adapter in accordance with aspects of the innovation.

FIG. 16 is an exploded side view of the isolator including the adapter of FIG. 15.

FIG. 17 is a cross-sectional front view of the isolator including the adapter of FIG. 15.

FIG. 18 is a cross-sectional side view of the isolator including the adapter of FIG. 15.

FIG. 19 is a perspective view of a platform included in the adapter of FIG. 15.

FIG. 20 is a perspective view of the platform of FIG. 19 aligned with a first sleeve included in the adapter of FIG. 15.

### DETAILED DESCRIPTION

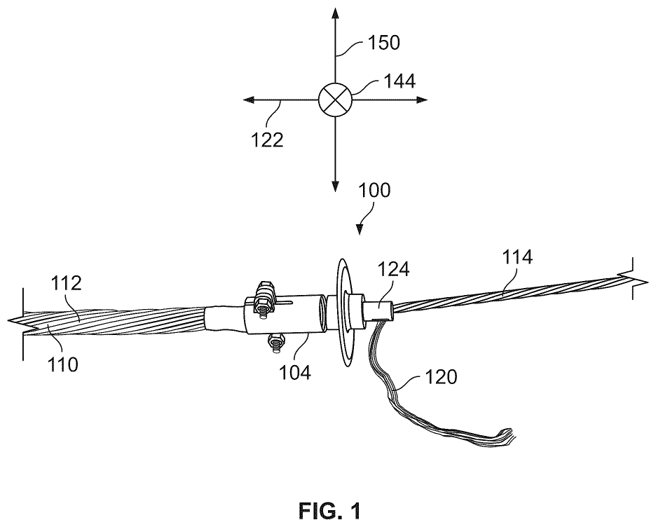

It should, of course, be understood that the description and drawings herein are merely illustrative, and that various modifications and changes can be made in the structures disclosed without departing from spirit and scope of the present disclosure. Referring now to the drawings, wherein like numerals refer to like parts throughout the several views, in accordance with an aspect of the innovation, FIG. 1 illustrates an isolator 100 including part of an isolator body 102 fixed with a cap 104. The isolator 100 receives a cable 110, including a jacket 112, at the cap 104. The isolator 100 and the cable 110 together form a cable assembly.

The cable 110 is a transmission cable that includes conductors 114 and an insert 120. The conductors 114 extend through the isolator 100 in a longitudinal direction of the isolator body 102 indicated by an arrow 122, where the conductors 114 are separated from the jacket 112 and the insert 120. With this construction, the conductors 114 are insulated from electric currents along the jacket 112 by the isolator body 102. While, as depicted, the cable 110 is an optical ground wire, the conductors 114 are a plurality of optical fibers, and the insert 120 is a strength member formed from fiber reinforced plastic (FRP), the cable 110 may be a variety of types for transmitting optical or electrical signals. Also, the cable 110 may include more or fewer of the conductors 114, and may include the conductors 114 as a variety of types such as copper, aluminum, silver, gold, and carbon in electrical transmission embodiments, and silica, polymer, and crystal fibers in optical embodiments.

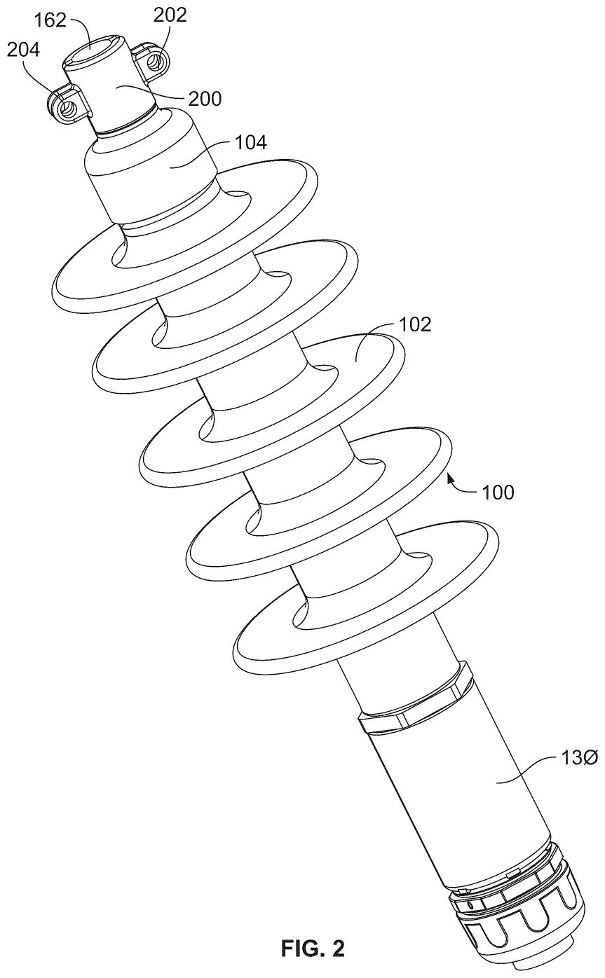

The isolator 100 also includes an insert 124 that retains the insert 120 with the isolator body 102, separate from the conductors 114. As such, the conductors 114 may be accessed at a proximal side of the isolator 100 without mechanical or electrical interference from the jacket 112 or the 120. FIG. 2 depicts a perspective view of the isolator 100, including an adapter 130 that prevents motion of the cable 110, and protects the cable 110 from exterior elements inside the isolator body 102.

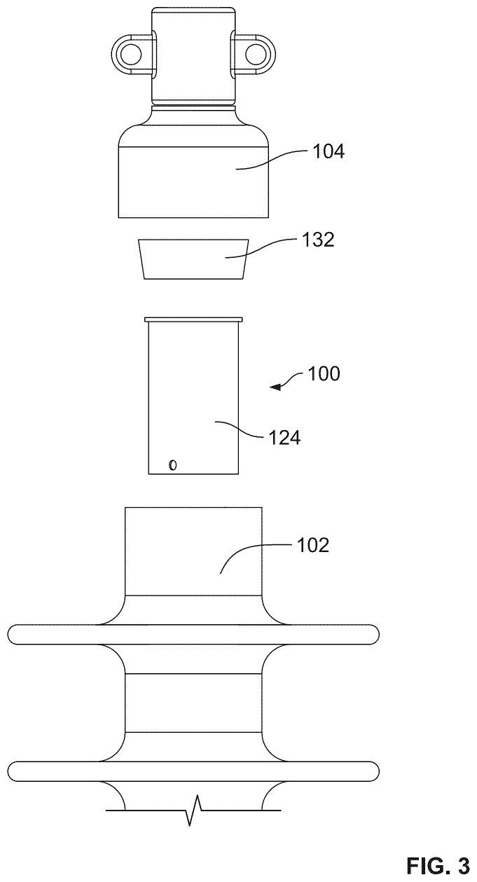

FIG. 3 depicts a partial exploded view of the isolator 100. As shown in FIG. 3, the isolator 100 includes a grommet 132 supported on the isolator body 102, between the cap 104 and each of the isolator body 102 and the insert 124 in the longitudinal direction of the isolator body 102. With this construction, as described in greater detail below, the cap 104 compresses the grommet 132 against the isolator body 102 and the insert 124 when engaged with the isolator body 102.

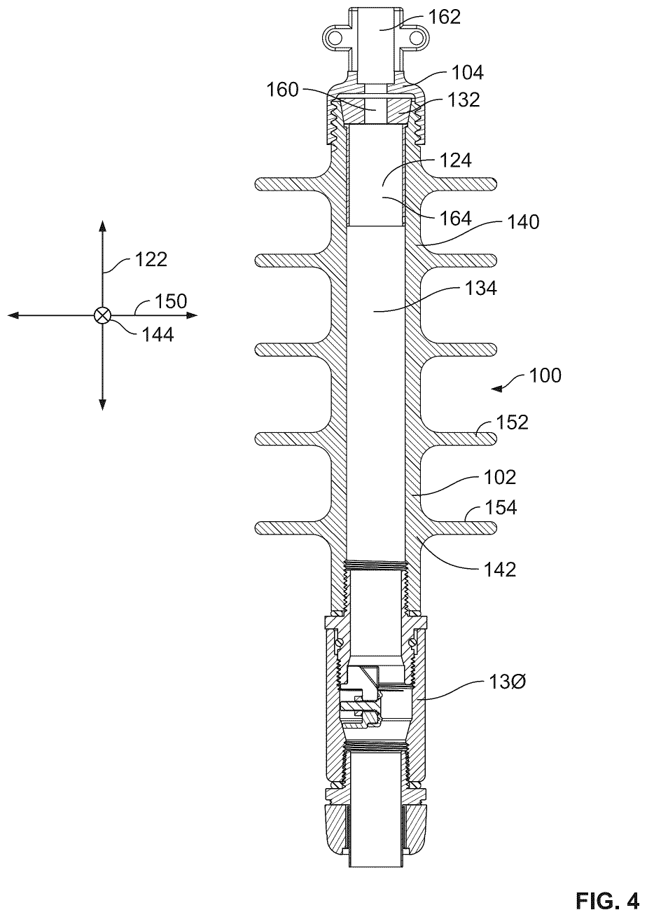

FIG. 4 depicts a cross-sectional side view of the isolator 100. As shown in FIG. 4, the isolator body 102 defines a first through hole 134 extended from a distal isolator end portion 140 to a proximal isolator end portion 142 in the longitudinal direction of the isolator body 102. The insert 124 and the grommet 132 are disposed in the first through hole 134 at the distal isolator end portion 140.

The isolator body 102 extends around the insert 124 and the grommet 132 in a lateral direction of the isolator body 102 perpendicular to the longitudinal direction, indicated by an arrow 144, and in a normal direction perpendicular to the longitudinal direction and the lateral direction, indicated by an arrow 150. The isolator body 102 includes sheds 152 which extend radially outward from the isolator body 102 in the lateral direction and the normal direction of the isolator body 102. The sheds 152 are offset from each other along the isolator body 102 in the longitudinal direction, from the distal isolator end portion 140 to the proximal isolator end portion 142.

With this construction, each of the sheds 152 is a plate that extends radially outward from the isolator 100, perpendicular to the longitudinal direction of the isolator body 102, and are rounded about the longitudinal direction. As such, the sheds 152 increase a surface distance from the distal isolator end portion 140 to the proximal isolator end portion 142 along an exterior surface 154 of the isolator body 102, increasing a creep distance of the isolator body 102 along the exterior surface 154, or an overall amount of electrical resistance by the isolator body 102 to current flow along the exterior surface 154. The sheds 152 also shield the exterior surface 154 from dust, dirt, water, and other debris, reliably maintaining the exterior surface 154 in a relatively clean, electrically resistive state.

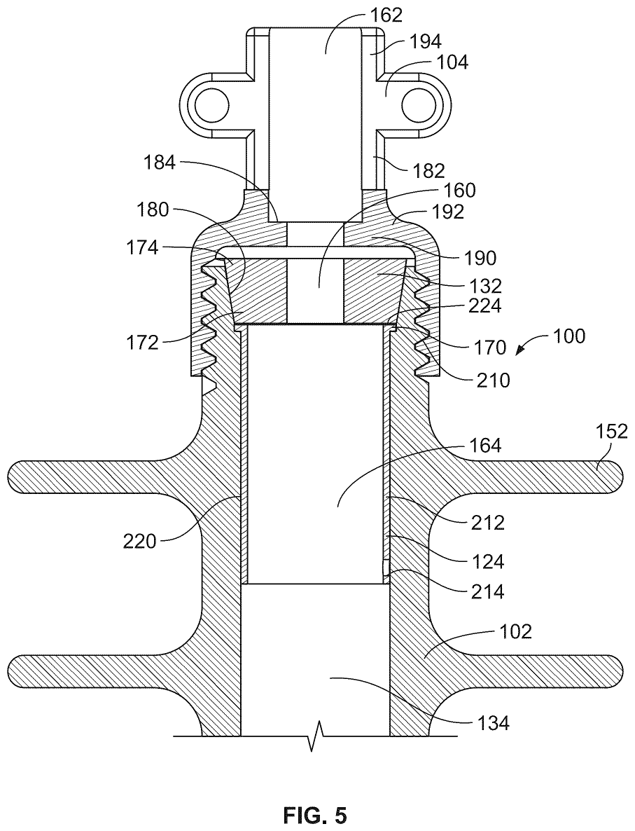

FIG. 5 depicts an enlarged, partial cross-sectional side view of the isolator 100 at the distal isolator end portion 140. As shown in FIG. 5, the grommet 132 defines a second through hole 160, the cap 104 defines a third through hole 162, and the insert 124 defines a fourth through hole 164. The first through hole 134, the second through hole 160, the third through hole 162, and the fourth through hole 164 overlap each other in the longitudinal direction of the isolator body 102. Further, the first through hole 134, the second through hole 160, the third through hole 162, and the fourth through hole 164 are coaxial with each other. In this manner, the first through hole 134, the second through hole 160, the third through hole 162, and the fourth through hole 164 form a conduit configured to receive the cable 110.

More specifically, the cap 104 receives the cable 110 including the jacket 112 in the first through hole 134. Also, the isolator body 102, the grommet 132, and the insert 124 respectively receive each of the conductors 114 and the insert 120 at the second through hole 160, the third through hole 162, and the fourth through hole 164, where the conductors 114 and the insert 120 extend from the jacket 112 at the cap 104.

With continued reference to FIG. 5, the isolator body 102 forms a ledge 170 in the first through hole 134 that supports a proximal grommet end portion 172 included in the grommet 132 in the longitudinal direction of the isolator body 102, inside the first through hole 134. The grommet 132 also includes a distal grommet end portion 174 that extends opposite from the proximal grommet end portion 172 in the longitudinal direction of the isolator body 102, outward from the first through hole 134, and beyond the isolator body 102 in the longitudinal direction. In this manner, the grommet 132 is supported on the isolator body 102 at the distal isolator end portion 140, where the grommet 132 defines the second through hole 160 aligned with the first through hole 134, such that the second through hole 160 overlaps the first through hole 134 in the longitudinal direction of the isolator body 102.

The isolator body 102 forms the ledge 170 in the first through hole 134 that supports the proximal grommet end portion 172 in the longitudinal direction of the isolator body 102, opposite the cap 104 when the cap 104 presses the distal grommet end portion 174 toward the isolator body 102. The cap 104 presses the distal grommet end portion 174 toward the isolator body 102 when the cap 104 engages the distal isolator end portion 140 in the longitudinal direction of the isolator body 102, across the grommet 132.

The grommet 132 is supported on the distal isolator end portion 140 between the cap 104 and the isolator body 102 in the longitudinal direction of the isolator body 102. The grommet 132 is disposed in the first through hole 134, the third through hole 162, or the fourth through hole 164.

In an embodiment, the second through hole 160 is cylindrical, and the inner width of the second through hole 160 is an inner diameter that reduces in size when the cap 104 presses the grommet 132 toward the isolator body 102. With this construction, the grommet 132 is shaped to uniformly grip and seal against a cylindrical portion the cable 110. The grommet 132 is formed from a material that is compressible as compared to the cable 110, the isolator body 102, the insert 124, and the cap 104. As such, the grommet 132 is configured to deform to a shape of and seal against the cable 110, the cap 104, and the isolator body 102 when the cap 104 engages the isolator body 102.

With continued reference to FIG. 5, the grommet 132 is supported directly on the isolator body 102, within the first through hole 134 at the distal isolator end portion 140 such that the distal grommet end portion 174 extends beyond the isolator body 102 in the longitudinal direction of the isolator body 102 when the grommet 132 is in an uncompressed state. The grommet 132 is directly supported on the isolator body 102 by a seat surface 180 that is disposed around and defines the first through hole 134 in the lateral direction and the normal direction of the isolator body 102. The isolator body 102 forms the seat surface 180 inclined radially inward with respect to the second through hole 160, along the longitudinal direction of the isolator body 102 from the distal isolator end portion 140 toward the proximal isolator end portion 142.

With this construction, the grommet 132 compresses against the isolator body 102 and the insert 124, and slides across the seat surface 180, along the incline of the seat surface 180, when the cap 104 presses the grommet 132 toward the isolator body 102. In this manner, the cap 104 engages the distal isolator end portion 140 in the longitudinal direction of the isolator body 102, across the grommet 132, where the cap 104 presses the grommet 132 toward the isolator body 102 and reduces a width of the second through hole 160 defined by the grommet 132 perpendicular to the longitudinal direction. As such, the grommet 132 seals against the cable 110, the insert 124, the isolator body 102, and the cap 104 when the cap 104 engages the isolator body 102, and prevents water, dust, or other debris from reaching the cable 110 from between the cap 104 and the isolator body 102.

The cap 104 includes a cap wall 182 that defines a third through hole 162 that overlaps the first through hole 134 and the second through hole 160 in the longitudinal direction. The cap 104 forms a step 184 in the third through hole 162 that reduces a width of the third through hole 162 along the longitudinal direction of the isolator body 102, toward the isolator body 102. In this regard, the step 184 forms a surface facing the cap 104 in the longitudinal direction of the isolator body 102.

The cap wall 182 directly engages the isolator body 102 in a threaded fit connection. The cap 104 includes a flange 190 that extends into the third through hole 162 from the cap wall 182 and forms the step 184. The flange 190 extends flatly inward with respect to the third through hole 162, and presses the grommet 132 toward the isolator body 102 when the cap wall 182 engages the isolator body 102.

With continued reference to FIG. 5, the cap 104 includes a proximal cap end portion 192 that forms the step 184, in this regard, the proximal cap end portion 192 forms the flange 190 and a portion of the cap wall 182 that supports the flange 190 and extends to the isolator body 102. The cap 104 also includes a distal cap end portion 194 formed from the cap wall 182 and extended from the proximal cap end portion 192.

As shown in FIG. 2, the cap 104 also includes a removable wall segment 200 that defines the third through hole 162 at the distal cap end portion 194. In this regard, the removable wall segment 200 includes first attachment points 202 aligned with second attachment points 204 included in the isolator body 102. The first attachment points 202 and the second attachment points 204 are through holes respectively defined in the removable wall segment 200 and the isolator body 102. The first attachment points 202 and the second attachment points 204 may receive fasteners such as nuts and bolts that fix the removable wall segment 200 with the isolator body 102. The third through hole 162 has an inner diameter between the isolator body 102 and the removable wall segment 200 sized such that the cap 104 presses into the cable 110 at the jacket 112, and reliably holds the cable 110 by the jacket 112 when the removable wall segment 200 is fixed with the isolator body 102 around the cable 110.

Referring back to FIG. 5, the third through hole 162 is cylindrical and has an inner diameter larger than a width of the first through hole 134, the second through hole 160, and the fourth through hole 164. With this construction, the cap 104 is configured to retain the cable 110 with the jacket 112 in a close fit, the grommet 132 is configured to seal against the cable 110 at the conductors 114 and the insert 120, and the insert 124 and the isolator body 102 retain the cable 110 with the conductors 114 and the insert 120 in a close fit.

The cap 104 engages the isolator body 102 through a linear drive mechanism 210 that converts a rotational motion between the cap 104 and the isolator body 102 to a linear motion which gradually drives the cap 104 toward the isolator body 102, and presses the grommet 132 when the cap 104 engages the isolator body 102. While, in the depicted embodiment, the linear drive mechanism 210 is threading between the cap 104 and the isolator body 102 that facilitates the threaded fit connection, the linear drive mechanism 210 may additionally or alternatively include a latch mechanism or other linear motion driver for engaging the cap 104 with the isolator body 102 without departing from the scope of the subject disclosure. With this construction, the cap 104 is supported on and engages the distal isolator end portion 140 through the linear drive mechanism 210, which moves the cap 104 in the longitudinal direction relative to the isolator body 102.

The insert 124 and the isolator body 102 are formed from a dielectric material as compared to the cap 104. In this regard, the cap 104 may be a metal, where the cap 104 closes on the jacket 112 at the removable wall segment 200, and holds the cable 110 in place with respect to the isolator body 102, the grommet 132, and the insert 124. With this construction, the cap 104 also prevents corona from breaking out of the rod end of the cable 110 where the jacket 112 is energized. The cap 104 also shields the grommet 132, the isolator body 102, and the insert 124 from any harsh edges formed at an end of the jacket 112 received in the cap 104, at the flange 190.

In this regard, the flange 190 may extend into the third through hole 162 a distance corresponding with a thickness of the jacket 112. With this construction, the flange 190 and the cap wall 182 are interposed between and separate the jacket 112 from the grommet 132, the isolator body 102, and the insert 124 in the longitudinal direction of the isolator body 102.

The insert 124 is held in the first through hole 134 between the grommet 132 and the isolator body 102 in the longitudinal direction. The insert 124 includes an insert wall 212 that extends from the grommet 132 in the longitudinal direction, along the first through hole 134 from the distal isolator end portion 140 toward the proximal isolator end portion 142, and the insert wall 212 includes a retention mechanism 214 that obstructs movement of the insert 120 as a cable 110 element inserted into the isolator body 102.

With continued reference to FIG. 5, the insert wall 212 extends along the first through hole 134 in the longitudinal direction from the distal isolator end portion 140 toward the proximal isolator end portion 142. In this regard, the insert wall 212 maintains constant proximity to the isolator body 102 in the lateral direction and the normal direction and extends along the first through hole 134 closer to a side of the first through hole 134 as compared to a middle. In the depicted embodiment, the insert wall 212 contacts the isolator body 102 along the first through hole 134.

In an embodiment, the insert wall 212 has a cylindrical outer surface 220, and the insert 124 includes an irregularity along the cylindrical outer surface 220 that engages the isolator body 102 and prevents rotation between the insert 124 and the isolator body 102 around the longitudinal direction of the isolator body 102. In this regard, the isolator body 102 and the insert 124 may include a catch mechanism with a protrusion and complementary catch positioned at mating surfaces of the isolator body 102 and the insert 124. In an alternative embodiment, the cylindrical outer surface 220 includes corners or sides that mate with the isolator body 102 in the first through hole 134 and obstruct rotation between the isolator body 102 and the cap 104 around the longitudinal direction of the isolator body 102.

The insert 124 includes a flange 224 extended radially outward from the fourth through hole 164, toward the isolator body 102 from the insert wall 212, perpendicular to the longitudinal direction of the isolator body 102. In this regard, the flange 224 extends from the insert wall 212 in the lateral direction and the normal direction of the isolator body 102.

The retention mechanism 214 obstructs movement of the insert 120 as an element of the cable 110 inserted into the isolator body 102. The retention mechanism 214 and an end portion of the insert 120 are located within the isolator body 102, such that the isolator body 102 covers the retention mechanism 214 and an end portion of the insert 120 from an exterior environment in the lateral direction and the normal direction of the isolator body 102. In this manner, the retention mechanism 214 is disposed in the first through hole 134, completely enclosed by the isolator body 102 perpendicular to the longitudinal direction.

The retention mechanism 214 is a slot defined by the insert wall 212 that the insert 120 is tied around, obstructing further movement of the insert 120 along the isolator body 102. The retention mechanism 214 may additionally or alternatively include a hook defined by the insert wall 212, a post extended from the insert wall 212, a clamp fixed with the insert wall 212, and a wedge formed from the insert wall 212 or other mechanism for retaining the insert 120 in the first through hole 134 of the isolator body 102 without departing from the scope of the subject disclosure.

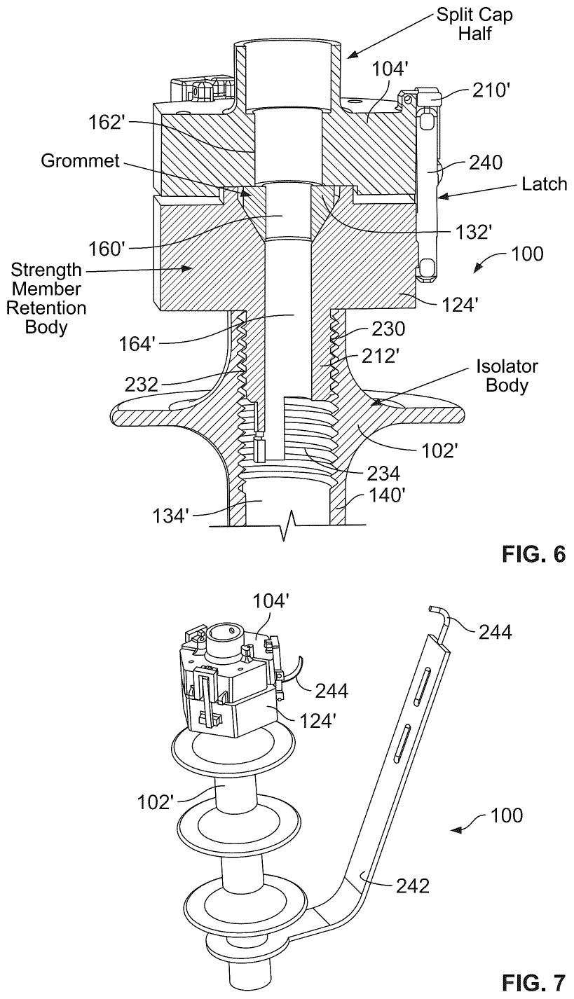

FIGS. 6 and 7 illustrate an alternate embodiment of the isolator 100 of FIGS. 1-5. In the embodiment of FIGS. 6 and 7, like elements with the isolator 100 of FIGS. 1-5 are denoted with the same reference numerals but followed by a primed suffix (′). As shown, FIG. 6 illustrates an embodiment of the isolator 100 where the insert 124′ is threaded onto the isolator body 102′ at the distal isolator end portion 140′, and the cap 104′ directly engages the insert 124′ to compress the grommet 132′ and seal the conduit formed from the first through hole 134′, the second through hole 160′, and the fourth through hole 164′.

More specifically, the insert wall 212′ directly engages the isolator body 102′ in a threaded fit connection. In this regard, the insert wall 212′ includes a first set of threads 230 along an exterior surface 232 of the insert wall 212′, and the isolator body 102 includes a complementary second set of threads 234 in the first through hole 134′, at the distal isolator end portion 140′ for engaging the first set of threads 230.

The cap 104′ includes the linear drive mechanism 210′ as a latch mechanism that drives the cap 104′ toward the isolator body 102′ and presses the grommet 132′ when the cap 104′ engages the isolator body 102′. The latch mechanism includes a handle 240 that, when rotated relative to the insert 124′, the grommet 132′, and the isolator body 102′, drives the cap 104′ toward the grommet 132′, against the insert 124′ and the isolator body 102′ in the longitudinal direction of the isolator body 102′.

With reference to FIG. 7, the isolator 100 also includes a bracket 242 that extends from the isolator body 102′, and a pair of arch horns 244 disposed on the isolator body 102′ and the bracket 242. With this construction, an electrical surge along the jacket 112 may be routed around the insert 124′ and the cap 104′, protecting the conductors 114 in the cable 110.

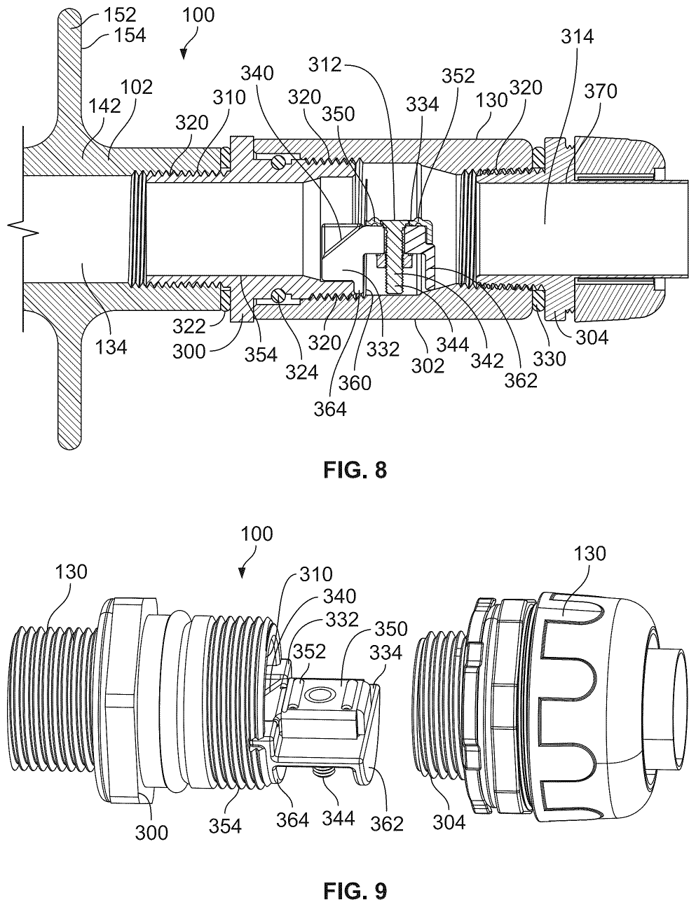

Referring back to FIG. 2, the isolator 100 includes the adapter 130, which closes the isolator body 102 around the conductors 114 at the proximal isolator end portion 142. FIG. 8 depicts a cross-sectional side view of the adapter 130 fixed with the distal isolator end portion 140. As shown in FIG. 8, the adapter 130 includes a first sleeve 300 directly engages the isolator body 102 at the distal isolator end portion 140. The adapter 130 also includes a second sleeve 302 directly engaged with the first sleeve 300 at a side of the first sleeve 300 opposite the isolator body 102. The adapter 130 also includes a third sleeve 304 engaged with the second sleeve 302 at a side of the second sleeve 302 opposite the first sleeve 300.

The third sleeve 304 is engaged with the second sleeve 302 at a side of the second sleeve 302 opposite the first sleeve 300 in the longitudinal direction, where the third sleeve 304 defines an interior of the adapter 130 continuously with the first sleeve 300 and the second sleeve 302. The second sleeve 302 defines the interior of the adapter 130 with a greater distance in the lateral direction and the normal direction than the first sleeve 300 or the third sleeve 304. As such, the interior of the adapter 130 is wider in the lateral direction and the normal direction at the second sleeve 302 as compared to the first sleeve 300 and the third sleeve 304.

The first sleeve 300, the second sleeve 302, and the third sleeve 304 respectively define a fifth through hole 310, a sixth through hole 312, and a seventh through hole 314 coaxially aligned with the first through hole 134, defining the interior of the adapter 130 continuously in the longitudinal direction from the first sleeve 300 at the isolator body 102 to the third sleeve 304. In this manner, the first sleeve 300, the second sleeve 302, and the third sleeve 304 form the conduit for receiving the cable 110 with the isolator body 102, the cap 104, the grommet 132, and the insert 124. The first sleeve 300 and the second sleeve 302 are directly engaged with each other, and define the interior of the adapter 130 in the lateral direction and the normal direction.

The isolator body 102, the first sleeve 300, the second sleeve 302, and the third sleeve 304 are connected to each other through threaded connections 320, where complementary threaded surfaces formed in the proximal isolator end portion 142, the first sleeve 300, the second sleeve 302, and the third sleeve 304 engage each other. The adapter 130 includes a first gasket 322 disposed between the first sleeve 300 and the distal isolator end portion 140 in the longitudinal direction of the isolator body 102, which seals the first sleeve 300 with the distal isolator end portion 140. The adapter 130 includes an O-ring 324 disposed around the first sleeve 300 in a circumferential direction around the longitudinal direction, where the O-ring 324 is interposed between and separates the first sleeve 300 and the second sleeve 302 in the lateral direction and the normal direction. The adapter 130 also includes a second gasket 330 disposed between the second sleeve 302 and the third sleeve 304 in the longitudinal direction of the isolator body 102.

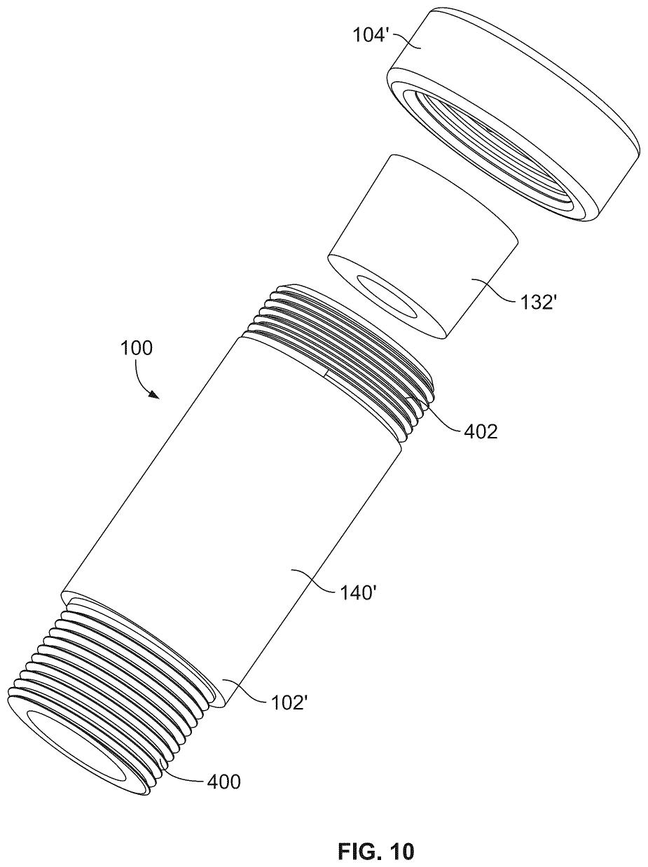

The adapter 130 includes an obstruction mechanism 332 that reduces a cross-sectional area of the sixth through hole 312. The obstruction mechanism 332 closes the sixth through hole 312 against the conductors 114, holding the conductors 114 in place relative to the isolator body 102 and the adapter 130. As shown in FIGS. 8 and 9, the obstruction mechanism 332 includes a platform 334 and a ramp 340 configured to guide the conductors 114 through the sixth through hole 312, where the second sleeve 302 defines the interior of the adapter 130.

The platform 334 is extended in the longitudinal direction, perpendicular to the lateral direction and the normal direction. The ramp 340 is extended flatly from the platform 334 toward the first sleeve wall 354 in the lateral direction and the longitudinal direction. With this construction, the conductor 114 slides through the interior of the adapter 130, around the ramp 340, and passed the platform 334, where a cross-sectional area of the interior is restricted in the lateral direction and the normal direction.

With reference to FIG. 8, the adapter 130 includes a height adjustment mechanism 342 supported on the platform 334 in the sixth through hole 312 at an adjustable height, where the height adjustment mechanism 342 may press the cable 110 against the sixth through hole 312 at a side of the second sleeve 302 opposite the height adjustment mechanism 342. The first sleeve 300 and the second sleeve 302 cooperatively house the obstruction mechanism 332 and the height adjustment mechanism 342 in the interior defined by the first sleeve 300 and the second sleeve 302.

The height adjustment mechanism 342 includes a fastener 344 fixed with a plate 350. The fastener 344 drives the plate 350 to an adjustable height with respect to the second sleeve 302, and the plate 350 presses the conductors 114 against the side of the second sleeve 302 defining sixth through hole 312 opposite the height adjustment mechanism 342.

With continued reference to FIG. 8, the fastener 344 is fixed with the plate 350 and the platform 334, where the fastener 344 supports the plate 350 a distance from the platform 334 in the normal direction. The fastener 344 is in threaded engagement with the platform 334 and fixed with the plate 350 such that rotating the fastener 344 relative to the platform 334 drives the plate 350 in the normal direction. With this construction, the plate 350 is spaced from the platform 334 in the normal direction an adjustable, predetermined distance fixed by the fastener 344. While in the depicted embodiment the fastener 344 is a bolt fixed with the plate 350 and retained in threaded engagement with the platform 334 by a nut, the fastener 344 may additionally or alternatively embody a machine screw, a leadscrew, or other threaded or graduated fastener extendable or slidable relative to the platform 334 for driving the plate 350 in the normal direction a predetermined distance without departing from the scope of the present disclosure.

The plate 350 includes ridges 352 that project in the normal direction toward a first sleeve wall 354 that forms the first sleeve 300, at a side of the first sleeve 300 opposite the platform 334. The first sleeve wall 354 forms the fifth through hole 310 and defines the interior of the adapter 130 at the first sleeve 300. The ridges 352 include a first ridge and a second ridge extended toward the first sleeve wall 354 in the normal direction, at opposite sides of the fastener 344 in the longitudinal direction. With this construction, compressive forces directed through the ridges 352 and toward the platform 334 are balanced across the fastener 344 in the longitudinal direction.

The fastener 344 may drive the plate 350 across the first sleeve 300 in the lateral normal, to the side of the first sleeve 300 opposite the platform 334, closing the interior at the first sleeve 300 against the first sleeve wall 354. The plate 350 faces the ridges toward a side of the first sleeve wall 354 and the second sleeve wall 360 opposite the platform 334 in the normal direction. As such, the plate 350, including the ridges 352, may contact the conductor 114 disposed in the interior at the first sleeve 300 and the second sleeve 302, and press the conductor 114 against the first sleeve wall 354 and the second sleeve wall 360 from the platform 334.

With continued reference to FIG. 8, the second sleeve 302 includes a second sleeve wall 360 that forms the sixth through hole 312 and defines the interior of the adapter 130 in the lateral direction and the normal direction. The obstruction mechanism 332 includes a support leg 362 that extends from the platform 334 in the normal direction, toward the second sleeve wall 360. The support leg 362 directly contacts the second sleeve wall 360, and supports the platform 334 in the interior, in the lateral direction and the normal direction, from an inner surface of the second sleeve wall 360 that forms the sixth through hole 312 and defines the interior of the adapter 130.

As shown in FIG. 9, the obstruction mechanism 332 includes a lip 364 that is a flange extended from the platform 334 or the ramp 340 beyond the interior in the lateral direction and the normal direction such that the lip 364 abuts the first sleeve wall 354 in the longitudinal direction. The lip 364 is extended from the platform 334 or the ramp 340 in opposite directions along the lateral direction, and the lip 364 is wider than the interior of the adapter 130 at the first sleeve 300 in the lateral direction. As depicted, the lip 364 extends radially outward from the platform 334 and the ramp 340, and abuts the first sleeve wall 354 along an inner periphery of the fifth through hole 310. With this construction, the obstruction mechanism 332 may be inserted in fifth through hole 310 to a predetermined position along the longitudinal direction, where the obstruction mechanism 332 is seated against the first sleeve wall 354 in the longitudinal direction.

Referring back to FIG. 8, the platform 334 is extended across the interior of the adapter 130 at the second sleeve 302, where the platform 334 contacts and abuts the second sleeve wall 360 at opposite sides of the second sleeve 302 in the lateral direction. With this construction, the second sleeve wall 360 obstructs the platform 334 from moving in the lateral direction. As the second sleeve wall 360 is cylindrical, the platform 334 may slide along the inner surface of the second sleeve wall 360 in the longitudinal direction and the circumferential direction, allowing threaded engagement between the first sleeve 300 and the second sleeve 302 with the obstruction mechanism 332 seated on the first sleeve 300.

The first sleeve 300 is engaged with the isolator body 102 at the distal isolator end portion 140, where the conductor 114 is configured to pass from the distal isolator end portion 140, into and through the interior of the adapter 130 in the longitudinal direction. In this regard, the conductor 114 extends around the platform 334, the ramp 340, the plate 350, and the fastener 344, where the plate 350 contacts and presses the conductor 114 toward the first sleeve wall 354 in the normal direction.

In this manner, the obstruction mechanism 332 and the height adjustment mechanism 342 stabilize and retain the conductor 114 in the adapter 130. More specifically, the first sleeve 300 is engaged with the isolator body 102 at the distal isolator end portion 140, and the conductor 114 passes from the distal isolator end portion 140 through the interior of the first sleeve 300, around the platform 334, the ramp 340, the plate 350, and the fastener 344, where the plate 350 contacts and presses the conductor 114 toward and against the first sleeve wall 354 in the normal direction.

The first sleeve wall 354 and the second sleeve wall 360 define the interior in the lateral direction and the normal direction. The third sleeve 304 includes a third sleeve wall 370 that defines the interior in the lateral direction and the normal direction with the first sleeve wall 354 and the second sleeve wall 360. The first sleeve wall 354 is fixed in threading engagement with the second sleeve wall 360, and the third sleeve wall 370 is fixed in threading engagement with the second sleeve wall 360 at a side of the second sleeve wall 360 opposite the first sleeve wall 354 in the longitudinal direction. The first sleeve wall 354, the second sleeve wall 360, and the third sleeve wall 370 are cylindrical, coaxial, and define the interior of the adapter 130 continuously in the longitudinal direction, from the distal isolator end portion 140 to a side of the third sleeve 304 opposite the second sleeve 302.

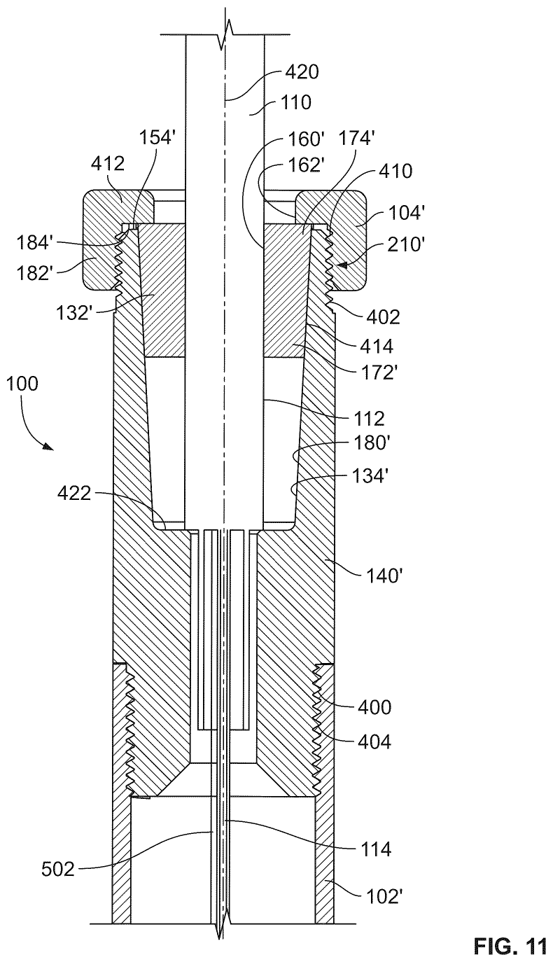

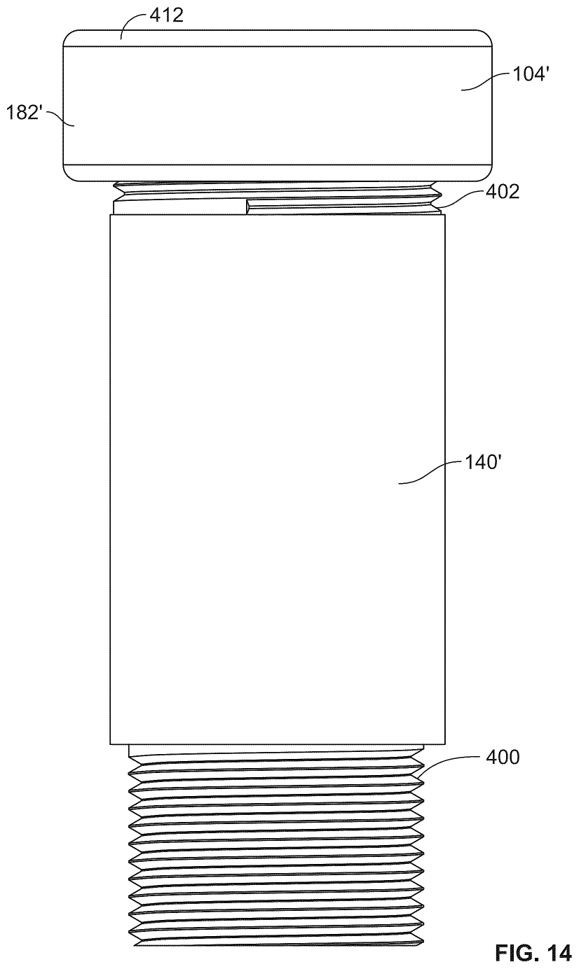

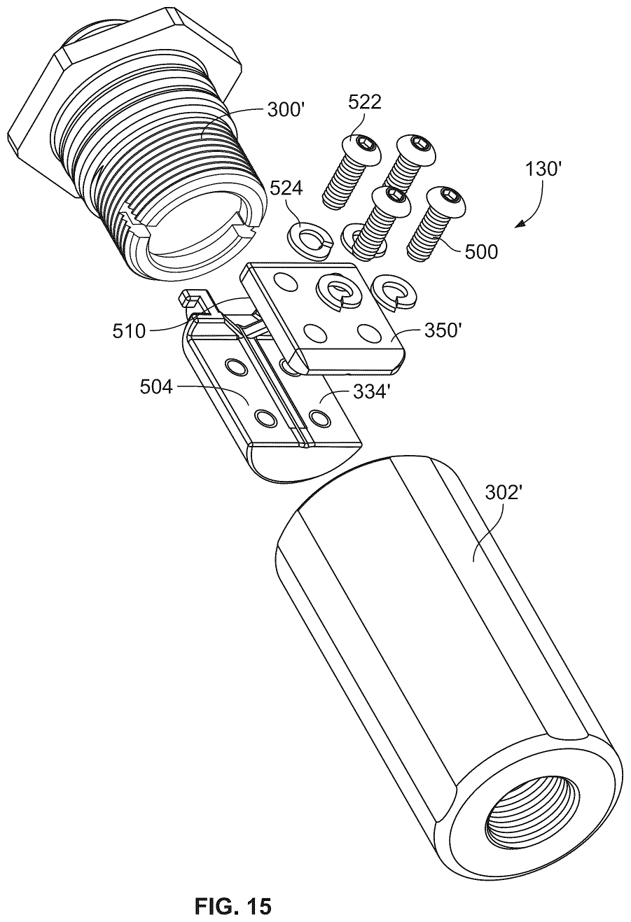

FIGS. 10-20 illustrate an alternate embodiment of the isolator 100 of FIGS. 1-9. In the embodiment of FIGS. 10-20, like elements with the isolator 100 of FIGS. 1-9 are denoted with the same reference numerals but followed by a primed suffix (′). As shown, FIG. 10 illustrates an embodiment of the isolator 100 where the distal isolator end portion 140′ is configured for being removably fixed with a remainder of the isolator body 102′ including the proximal isolator end portion 142′ (see FIG. 4). Notably, the distal isolator end portion 140′ may be interchangeably described as part of the isolator body 102′, as a removable end piece considered a portion of the cap 104′, where the cap 104′ is a first cap body and the distal isolator end portion 140′ is a second cap body, or otherwise separate from the isolator body 102′ without departing from the scope of the present disclosure.

The distal isolator end portion 140′ is a cylindrical wall closed around the longitudinal direction, and including a first threaded surface 400 and a second threaded surface 402. As shown in FIG. 11, the cylindrical wall forming the distal isolator end portion 140′ includes the first threaded surface 400, which engages a complementary isolator threaded surface 404 of the remainder of the isolator body 102′ in the longitudinal direction. With this construction, rotating the distal isolator end portion 140′ about the longitudinal direction linearly drives and fixes the distal isolator end portion 140′ in the longitudinal direction relative to the remainder of the isolator body 102′.

The distal isolator end portion 140′ forms the second threaded surface 402 at an end opposite the first threaded surface 400 in the longitudinal direction, where the second threaded surface 402 engages a complementary cap threaded surface 410. With this construction, the second threaded surface 402 and the cap threaded surface 410 may form the linear drive mechanism 210′, where rotating the cap 104′ about the longitudinal direction linearly drives the cap 104′ in the longitudinal direction relative to the distal isolator end portion 140′, and causes the distal isolator end portion 140′ to engage the cap 104′ across the grommet 132′ in the longitudinal direction. In this manner, the cap 104′ includes the linear drive mechanism 210′ that drives the cap 104′ toward the isolator body 102′ and presses the grommet 132′ when the cap 104′ engages the isolator body 102′. The depicted embodiment of the linear drive mechanism 210′ including threaded surfaces of the cap wall 182′ and the isolator body 102′ engaged with each other, where the threaded surfaces drive the cap 104′ toward the isolator body 102′ when the cap 104′ rotates about the longitudinal direction. As such, the linear drive mechanism 210′ converts a manually driven rotational motion of the cap 104′ relative to the isolator body 102′ into a linear motion of the cap 104′ in the longitudinal direction relative to the isolator body 102′.

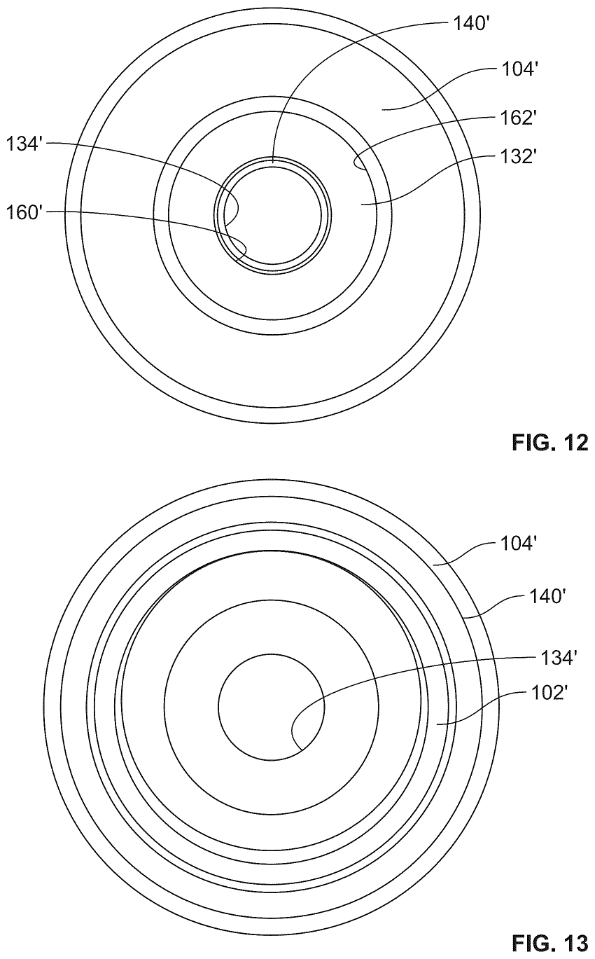

With continued reference to FIG. 11, the isolator body 102′ defines the first through hole 134′ extended from the distal isolator end portion 140′ toward the proximal isolator end portion 142′ (see FIG. 4) in the longitudinal direction of the isolator body 102′. The cap 104′ includes the cap wall 182′ that defines the third through hole 162′, which overlaps the first through hole 134′ and the second through hole 160′ in the longitudinal direction. More specifically, as shown in FIGS. 11-14 the cap 104′ is centered on the distal isolator end portion 140′, and as shown in FIG. 12, the third through hole 162′ is centered in the cap 104′ such that the second through hole 160′ and the third through hole 162′ are coaxial with each other and centered with the isolator body 102′.

Referring back to FIG. 11, the grommet 132′ is supported on the isolator body 102′ at the distal isolator end portion 140′, where the grommet 132′ defines the second through hole 160′. The second through hole 160′ overlaps the first through hole in the longitudinal direction. More specifically, the seat surface 180′ centers the grommet 132′ in the first through hole 134′, and the second through hole 160′ is centered in the grommet 132′ such that, as shown in FIG. 12, the first through hole 134′ and the second through hole 160′ are coaxial with each other and centered in the isolator body 102′. With this construction, the cable 110 is spaced an even radial distance from the cap 104′ and the distal isolator end portion 140′ at the first through hole 134′, and less likely to experience wear against the isolator body 102′ during installation and operation.

Referring back to FIG. 11, the cap 104′ also includes the step 184′, which extends inward in the lateral direction from the cap wall 182′ and defines the third through hole 162′, where the step 184′ reduces a width of the third through hole 162′ and presses the grommet 132′ toward the isolator body 102′ in the longitudinal direction. The cap 104′ includes a flange 412 that extends radially inward form the cap wall 182′ in the lateral direction, where the flange 412 forms the step 184′. The cap 104′ terminates at the flange 412 in the longitudinal direction, reducing an overall size of the isolator 100 in the longitudinal direction.

The grommet 132′ is supported on the isolator body 102′ within the first through hole 134′ at the distal isolator end portion 140′. The grommet 132′ is elastic and compressible as compared to the cable 110, the distal isolator end portion 140′, and the cap 104′. Also, the grommet 132′ is sized and shaped such that the grommet 132′ extends outward from the first through hole 134′ in the longitudinal direction when the grommet 132′ is seated in the first through hole 134′ in an uncompressed state. With this construction, when the linear drive mechanism 210′ drives the cap 104′ toward the distal isolator end portion 140′, the flange 412 presses the grommet 132′ inward in the longitudinal direction at the distal grommet end portion 174′ compresses the grommet 132′ against the seat surface 180′ and the cable 110.

With continued reference to FIG. 11, the distal grommet end portion 174′ is inserted in the third through hole 162′ defined by the cap wall 182′ in the lateral direction and the normal direction, while the proximal grommet end portion 172′ is inserted in the first through hole 134′ defined by the distal isolator end portion 140′. The grommet 132′ terminates at or before the step formed by the flange 412 in the longitudinal direction. With this construction, the grommet 132′ remains fully contained within the cap 104′ and the isolator body 102′, which prevent the grommet from projecting outward in an exposed condition between the cap 104′ and the cable 110, reducing susceptibility of the grommet 132′ to environmental wear, ultraviolet degradation, or mechanical damage during installation or operation.

The grommet 132′, including the proximal grommet end portion 172′ and the distal grommet end portion 174′, is directly supported on the isolator body 102 by the seat surface 180′ along an exterior surface 414 of the grommet 132′ in the lateral direction and the normal direction. The seat surface 180′ and the exterior surface 414 of the grommet 132′ form smooth, matching, complementary shaped surfaces that seal the grommet 132′ against the distal isolator end portion 140′ at the first through hole 134′.

The seat surface 180′ is inclined inward along the longitudinal direction, where the seat surface 180′ reduces a width of the first through hole 134′ along the longitudinal direction from the exterior surface 154′ of the isolator body 102′ toward an interior of the isolator body 102′. The seat surface 180′ is radially symmetric about the longitudinal direction, centered in the first through hole 134′, and inclined flatly along the longitudinal direction, having an inverted conical shape in the isolator body 102′.

The grommet 132′ is shaped as a truncated cone extending along a longitudinal axis 420, where the grommet 132′ is radially symmetric about the longitudinal axis 420 and defines a straight cylindrical through hole concentric with the longitudinal axis 420 as the second through hole 160′. Each of the first through hole 134′, the second through hole 160′, and the third through hole 162′ are coaxial with each other and centered on the longitudinal axis 420. As such, when the linear drive mechanism 210′ drives the cap 104′ and uniformly presses the grommet 132′ toward the isolator body 102′, the grommet 132′ slides across and compresses against the seat surface 180′ in the longitudinal direction, and radially inward toward the cable 110 with evenly distributed force.

With continued reference to FIG. 11, the seat surface 180′ is an exterior surface open to a user in the longitudinal direction. With this construction, a user may insert the grommet 132′ into the first through hole 134′ by hand when assembling the isolator 100. The seat surface 180′ is inclined inward at an angle less than 30 degrees from the longitudinal direction. More specifically, the seat surface 180′ is inclined inward at an angle less than 15 degree from the longitudinal direction. Also, the proximal grommet end portion 172′ is closer to the exterior surface 154′ of the isolator body 102′ at the first through hole 134′ in the longitudinal direction as compared to the distal grommet end portion 174′. With this construction, a user may wedge the grommet 132′ between the distal isolator end portion 140′ and the cable 110 by hand, where the grommet 132′ travels a sufficient distance in the longitudinal direction for the distal isolator end portion 140′ to reliably retain the grommet 132′ in the first through hole 134′ when assembling the isolator 100.

The isolator body 102′ forms a shoulder 422 in the first through hole 134′ that extends inward in the lateral direction from the seat surface 180′. More specifically, the shoulder 422 extends radially inward, reducing a width of the first through hole 134′ in the lateral direction a predetermined distance corresponding with the jacket 112 of the cable 110. In this regard, the width of the first through hole 134′ at the shoulder 422 is less than a width of the jacket 112, and larger than a collective width of the conductors 114 extended from the jacket 112. With the grommet 132′ sealed against the jacket 112 and the shoulder 422 extended inward, obstructing the jacket 112 in the longitudinal direction, the first through hole 134′ is narrower than the second through hole 160′ at the shoulder 422. With this construction, the shoulder 422 catches and obstructs the jacket 112 from traveling passed the distal isolator end portion 140′, and passes the conductors 114 in the longitudinal direction, while the grommet 132′ seals against the jacket 112 at the second through hole 162′.

The shoulder 422 extends radially inward from the seat surface 180′ toward the cable 110, where the shoulder 422 contacts the jacket 112. With this construction, the seat surface 180′ and the shoulder 422 overlap at least most of the grommet 132′ in the longitudinal direction. As such, the grommet 132′ is obstructed from passing the distal isolator end portion 140′ in the longitudinal direction during assembly or operation of the isolator 100, and may additionally be supported on the shoulder 422 as a seat surface against the cap 104′.

With continued reference to FIG. 11, the seat surface 180′ extends from the exterior surface 154′ at the first through hole 134′ toward the interior of the isolator body 102′, and is longer than the grommet 132′ in the longitudinal direction. As such, the grommet 132′ and the shoulder 422 define a cavity in the longitudinal direction, where the grommet 132′ is retained by contact with the cable 110, the seat surface 180′, and the flange 412, while being able to expand toward the flange 412. With this construction, the grommet 132′ forms a continuous sealing interface along the cable 110, the seat surface 180′, and the flange 412 while remaining isolated from other internal structures in the isolator body 102′ reducing frictional wear during assembly. As such, the grommet 132′ avoids stress concentrations along irregular surfaces, enhances uniform radial compression of the grommet 132′ against the cable 110, and simplifies placement of the grommet 132′ in the first through hole 134′ during assembly of the isolator 100.

When the linear drive mechanism 210′ advances the cap 104′ toward the isolator body 102′, the cap 104′ engages the distal isolator end portion 140′ across the grommet 132′ in the longitudinal direction. In this manner, the flange 412 presses the grommet 132′ toward the isolator body 102′, into the first through hole 134′, and compresses the grommet 132′ against both the seat surface 180′ and the cable 110. Each of the distal grommet end portion 174′ and the proximal grommet end portion 172′ contact the seat surface 180′, and an angular offset of the seat surface 180′ matches the exterior surface 414 of the grommet 132′ at the proximal grommet end portion 172′ and the distal grommet end portion 174′. As such, the seat surface 180′ uniformly presses the grommet 132′ radially inward toward the cable 110 at the second through hole 160′ in the lateral direction and the normal direction from both the proximal grommet end portion 172′ and the distal grommet end portion 174′.

Compression of the grommet 132′ reduces a width of the second through hole 160′ in the lateral direction orthogonal to the longitudinal direction, the width being an inner diameter of the grommet 132′ that contracts as the cap 104′ drives the grommet 132′ inward from an exterior of the isolator body 102′ toward the interior defined by the distal isolator end portion 140′. With this construction, the grommet 132′ elastically deforms into sealing engagement with the jacket 112, the distal isolator end portion 140′, and the cap 104′, obstructing the passage of water, dust, or debris through the conduit.

The second through hole 160′ is cylindrical and dimensioned to match an exterior surface of the cable 110 at the jacket 112, such that compression of the grommet 132′ forms a uniform, circumferential seal along the jacket 112. In alternative embodiments, the second through hole 160′ may be shaped to correspond with non-cylindrical cable jackets, including elliptical jackets, figure-8 jackets, or other industry-recognized cross-sectional profiles, where the grommet 132′ compresses to form a conformal seal around the selected jacket geometry without departing from the scope of the present disclosure.

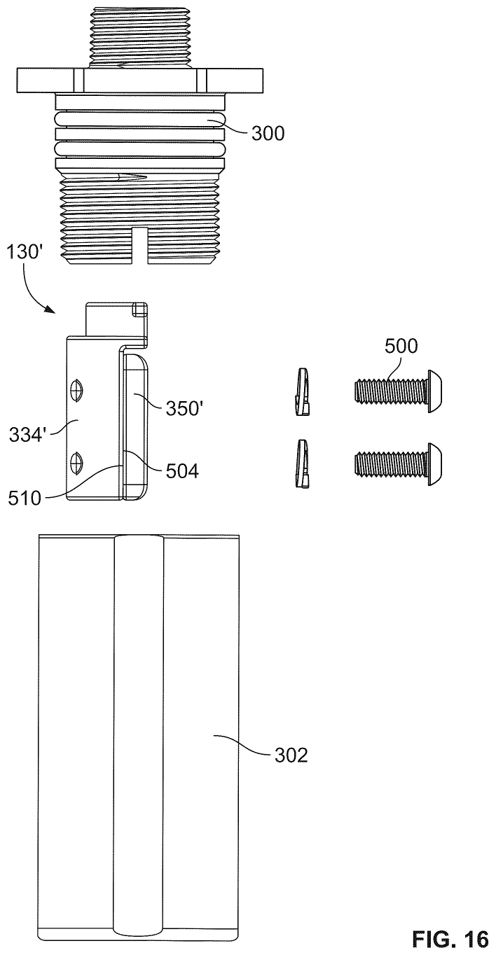

FIGS. 15-20 depict an embodiment of the adapter 130′ that closes the isolator body 102′ around the conductors 114 at the proximal isolator end portion 142′ (see FIG. 4). As shown in FIGS. 15 and 16, the adapter 130′ includes the first sleeve 300′, the second sleeve 302′, the platform 334′, the plate 350′, and fasteners 500. The fasteners 500 fix the platform 334′ with the plate 350′ at opposite sides of the insert 120 (see FIG. 11) in the cable 110, obstructing or preventing motion of the insert 120 relative to the first sleeve 300′, the second sleeve 302, and the isolator body 102′. In an embodiment, the insert 120 is a strength member disposed in the jacket 112 with the conductors 114, where the insert 120 increases a structural integrity of the cable 110.

The platform 334′ forms a first planar surface 504 that is extended flatly in the longitudinal direction and the lateral direction. As shown in FIG. 16, the plate 350′ forms a second planar surface 510 that is extended flatly in the longitudinal direction, along the first planar surface 504, where the second planar surface 510 overlaps the first planar surface 504 in the normal direction.

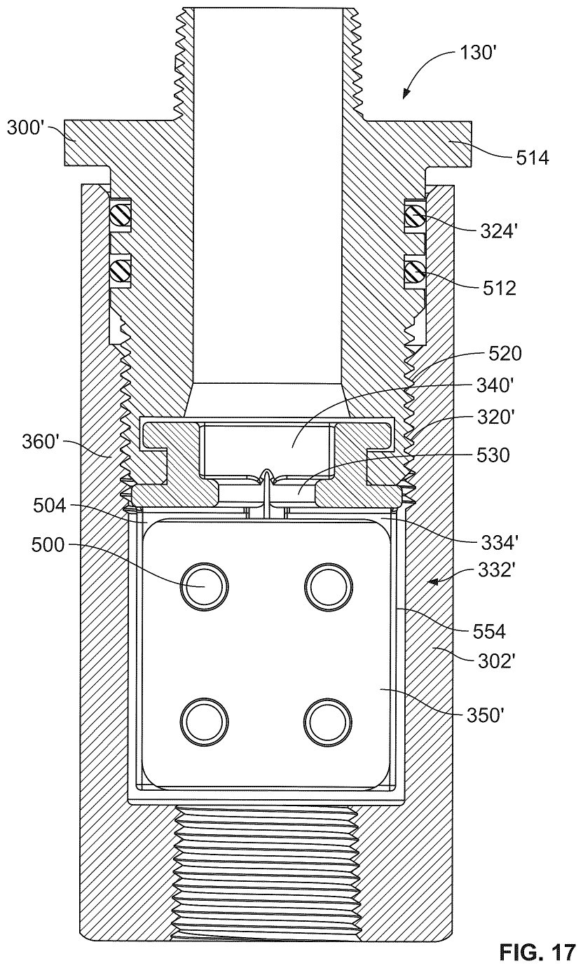

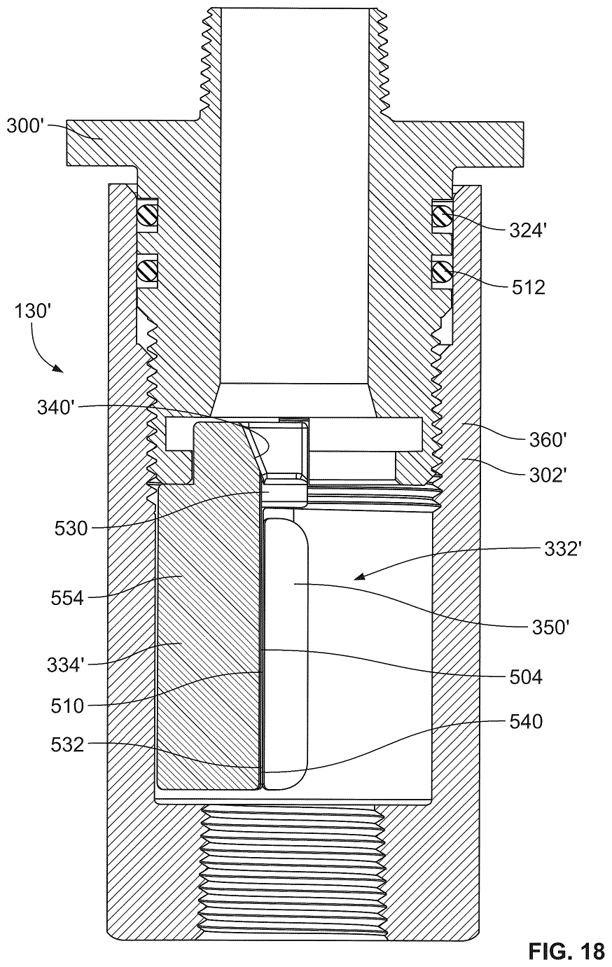

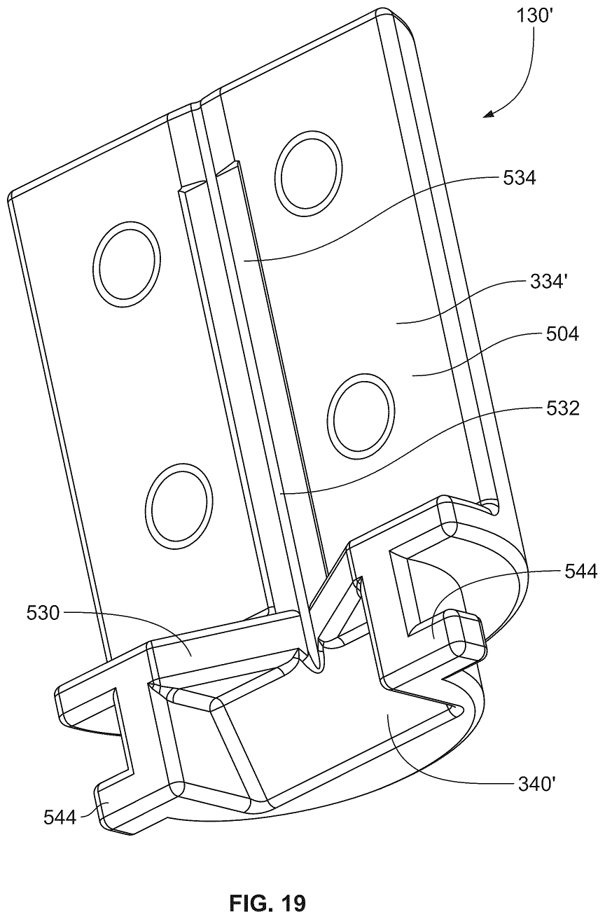

FIGS. 17 and 18 depict the obstruction mechanism 332′, including the platform 334′ and the plate 350′, fixed with the first sleeve 300′ and disposed within the interior of the adapter 130′ defined at the second sleeve 302′. The second sleeve 302′ engages the first sleeve 300′ in the longitudinal direction, and defines the interior of the adapter 130′ continuously with the first sleeve 300′. More specifically, the second sleeve 302′ defines the interior of the adapter 130′ in the lateral direction and the normal direction, where the interior of the adapter 130′ continues in the longitudinal direction from the first sleeve 300′ to the second sleeve 302′. The second sleeve 302′ abuts the platform 334′ or the plate 350′ at a side of the platform 334′ or the plate 350′ opposite the first sleeve 300′ in the longitudinal direction. In this manner, the first sleeve 300′ and the second sleeve 302′ prevent rotation about the longitudinal direction between the platform 334′ or the plate 350′ and the first sleeve 300′ when the second sleeve 302′ is assembled with the first sleeve 300′.

The adapter 130′ includes the O-ring 324′ as a first O-ring, and includes a second O-ring 512. The first O-ring 324′ and the second O-ring 512 are offset from each other in the longitudinal direction, and are each interposed between and separate the first sleeve 300′ and the second sleeve 302′ in the lateral direction and the normal direction, where the first O-ring 324′ and the second O-ring 512 seal the interior of the adapter 130′.

The adapter 130′ includes a flange 514 extended from the first sleeve 300′ in the lateral direction, where the flange 514 may abut the isolator body 102′ or the second sleeve 302′ in the longitudinal direction, sealing the interior of the adapter 130′. The flange 514 is a continuous ring that provides a mechanical stop between the first sleeve 300′ and the second sleeve 302′, and between the first sleeve 300′ and the isolator body 102′.

The adapter 130′ includes threads 520 on an exterior surface of the first sleeve 300′ at a side of the flange 514 opposite the O-ring 324′ in the longitudinal direction. The first sleeve 300′ is configured to directly engage the isolator body 102′ at the proximal isolator end portion 142′ (see FIG. 4), and the second sleeve 302′ is directly engaged to the first sleeve 300′ at a side of the first sleeve 300′ opposite the isolator body 102′ in the longitudinal direction. In assembly, the first sleeve 300′ is fixed directly to the isolator body 102′, the platform 334′ and the plate 350′ are positioned within the first sleeve 300′, the first O-ring 324′ and the second O-ring 512 are disposed around the first sleeve 300′ between the first sleeve 300′ and the second sleeve 302′, and the second sleeve 302′ is advanced along the threads 320′ until the flange 514 abuts the second sleeve 302′ in the longitudinal direction, compressing the first O-ring 324′ and the second O-ring 512, and sealing the interior of the adapter 130′. With this construction, the adapter 130′ features a relatively compact design that places the sealed end of the first sleeve 300′ immediately opposite the isolator body 102′, reducing a size of the adapter 130′ in the longitudinal direction and reducing installation space while easing handling.

Referring back to FIG. 15, the fasteners 500 fix the platform 334′ and the plate 350′ together within the interior of the adapter 130′ defined by the second sleeve 302′. Each fastener 500 includes a threaded shaft that extends through the plate 350′ and engages the platform 334′ in threaded connection. In this regard, rotating the fastener 500 advances the threaded shaft relative to the platform 334′ and presses the plate 350′ toward the platform 334′ in the normal direction, while pulling the platform 334′ toward the plate 350′ in the normal direction.

The fasteners 500 include bolts 522 and washers 524. The bolts 522 extend through the plate 350′ and engage the platform 334′, and the plate 350′ fixes to the bolts 522 so that rotating the bolts 522 relative to the platform 334′ drives the plate 350′ in the normal direction relative to the second sleeve wall 360′. The washers 524 are split lock washers that sit in the normal direction between the bolts and the plate 350′, generate friction between the bolts 522 and the platform 334′, and maintain secure engagement after assembly. The fasteners 500 include four sets of the bolts 522 and the washers 524 arranged in a square pattern that evenly distributes force between the plate 350′ and the platform 334′, providing uniform compression and stability of the assembly.

The interior of the adapter 130′ protects the fasteners 500 from external environmental conditions. By housing the fasteners 500 entirely within the adapter 130′, the second sleeve 302′ shields the bolts 522 and the washers 524 from exposure to moisture, dust, debris, and other contaminants that may be present in a surrounding external environment, reducing risk of corrosion, seizing, or degradation of the fasteners 500 over time.

The fasteners 500 are oriented in the normal direction, perpendicular to the first planar surface 504 and the second planar surface 510, such that actuating the fasteners 500 presses the plate 350′ toward the platform 334′ in the normal direction and pulls the platform 334′ toward the plate 350′ in the normal direction, securely clamping the insert 120 between the platform 334′ and the plate 350′. With this construction, the plate 350′ and the platform 334′ accommodate a variety of insert sizes, provide flexibility for different cable configurations, and reliably retain the insert 120 within the adapter 130′.

As shown in FIGS. 17 and 18, the ramp 340′ is extended from the platform 334′ toward the second sleeve wall 360′ in the normal direction and the longitudinal direction. The ramp 340′ is a continuous, flat surface integrally formed with the platform 334′, and is oriented at an angle of approximately 30 to 60 degrees relative to the platform 334′ to provide space-efficient cable guidance. The ramp 340′ directly contacts the insert 120 during assembly and operation, and the angle of the ramp 340′ avoids abrupt transitions that could form abrasive surfaces or sharp corners, reducing the risk of damage to the insert 120 or the conductors 114.

With reference to FIG. 19, the platform 334′ defines a first channel 532 in the first planar surface 504 that extends in the longitudinal direction from the ramp 340′ to an opposite side of the platform 334′ along the first planar surface 504. The adapter 130′ includes rails 530 that, when inserted in the second sleeve 302′ extend from the platform 334′ and the ramp 340′ toward the second sleeve wall 360′ from the first channel 532 in the lateral direction and the normal direction. More specifically, the rails 530 are interposed between and separate the ramp 340′ and the first planar surface 504 along the platform 334′ in the longitudinal direction. The rails 530 are oriented perpendicular to the ramp 340′ in the lateral direction, mirrored about the first channel 532 in the lateral direction, extend from the platform 334′ opposite the ramp 340′ in the normal direction, and extend from the first channel 532 in the lateral direction.

The rails 530 form a continuous structure with the platform 334′ and the ramp 340′, which are integrally formed with each other as a single component. The rails 530 and the ramp 340′ are rigidly fixed with the platform 334′ and do not move relative to the platform 334′. While, as depicted, the rails 530 include flat top surfaces and rounded corners that avoid scratching or damaging the conductors 114 or the insert 120, the rails 530 may additionally or alternatively be shaped to smoothly accommodate various particular cable or insert configurations without departing from the scope of the present disclosure.

With this construction, the ramp 340′ and the rails 530 cooperatively guide the insert 120 into the first channel 532 in the lateral direction and the normal direction. The ramp 340′ and the rails 530 provide general guidance for the insert 120 during assembly, where the insert 120 slides along the ramp 340′ and between the rails 530 into position along the first channel 532 in the longitudinal direction. As such, the ramp 340′ and the rails 530 guide correct installation, improve alignment, ease assembly, and help prevent damage to the insert 120 or the conductors 114 during installation.

In operation, the adapter 130′ receives the cable 110 with the conductor 114 and the insert 120 that extend through the first sleeve 300′ and the second sleeve 302′ in the longitudinal direction. In this regard, the conductor 114 passes the platform 334′ and the plate 350′ in the longitudinal direction at a side of the plate 350′ opposite the platform 334′ in the normal direction, and the insert 120 is interposed between the platform 334′ and the plate 350′ in the normal direction. With this construction, the insert 120 is retained in the interior of the adapter 130′, terminating in the second sleeve 302′ in the longitudinal direction, while the conductor 114 extends through the adapter 130′.

FIG. 19 is a perspective view of the platform 334′ including the ramp 340′, the rails 530, and the first planar surface 504 defining the first channel 532. The rails 530 are inclined from the first channel 532 in the lateral direction and the normal direction, and extend beyond the first planar surface 504 in the normal direction, opposite the ramp 340′. With this construction, the ramp 340′ and the rails 530 cooperatively guide the insert 120 into the first channel 532 and retain the insert 120 in position between the platform 334′ and the plate 350′.

The platform 334′ defines cutouts 534 adjacent to the first channel 532, which create space between the plate 350′ and the platform 334′ when the first planar surface 504 is pressed against the second planar surface 510. The cutouts 534 allow the insert 120 to expand into available space adjacent the first channel 532 if, in an embodiment, the first planar surface 504 and the second planar surface 510 excessively compress the insert 120, which avoids damaging the insert 120 and helps maintain reliable retention and alignment of the insert 120 within the adapter 130′.

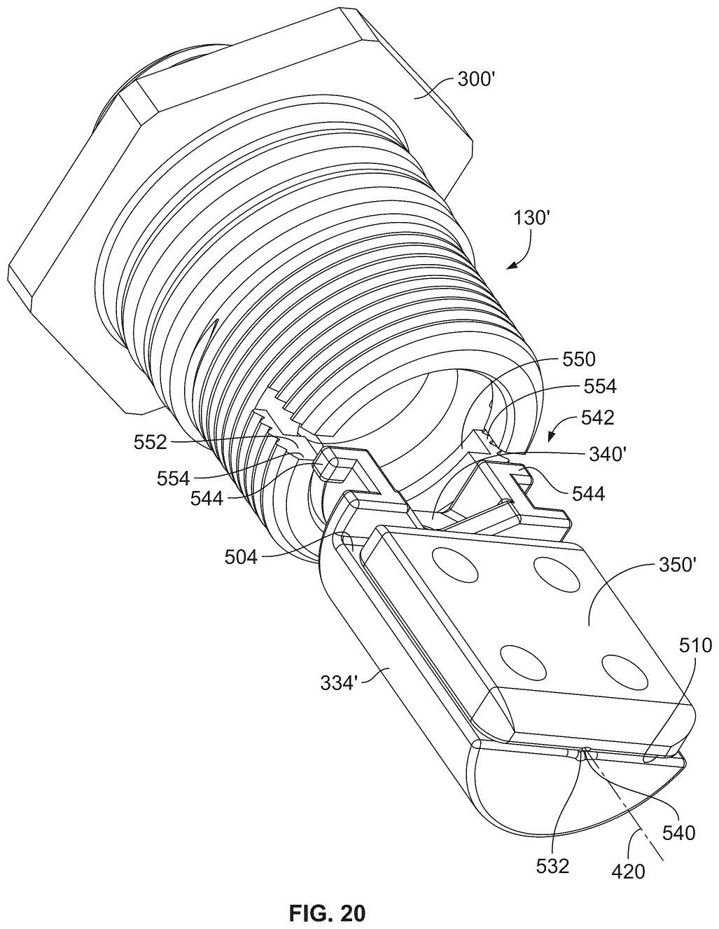

As shown in FIG. 20, the platform 334′ defines the first channel 532 in the first planar surface 504, and the plate 350′ defines a second channel 540 in the second planar surface 510. The first channel 532 and the second channel 540 are sized and shaped to press against and retain the insert 120 within the interior of the adapter 130′ defined by the second sleeve 302′. More specifically, the first channel 532 and the second channel 540 are aligned in the lateral direction and oriented opposite each other in the normal direction such that actuating the fasteners 500 drives the platform 334′ and the plate 350′ in the normal direction against opposite sides of the insert 120 at the first channel 532 and the second channel 540.

The longitudinal axis 420 is a central longitudinal axis of the first sleeve 300′ and the second sleeve 302′. The platform 334′ and the plate 350′ respectively define the first channel 532 and the second channel 540 as located closer to the longitudinal axis 420 as compared to the second sleeve wall 360′ in the lateral direction or the normal direction. As such, the platform 334′ and the plate 350′ avoid excessively bending the insert 120 in the adapter 130′.

The first channel 532 and the second channel 540 are sized and shaped to match an exterior surface of the insert 120. With this construction, the platform 334′ and the plate 350′ uniformly distribute compressive force along the insert 120, and avoid overly compressing the insert 120 or applying excessive pressure to any specific part of the insert 120, maintaining reliable retention and alignment of the insert 120 within the adapter 130′.

In an embodiment, the plate 350′ also defines cutouts in the second planar surface 510, extended adjacent the second channel 540 in the lateral direction and the longitudinal direction. More specifically, the cutouts defined in the second planar surface 510 extend directly from the second channel 540 in the lateral direction and continues along the first channel 532 in the longitudinal direction. In such an embodiment, the cutouts defined in the second planar surface 510 include similar features and function in a similar manner as the cutouts 534 defined in the first planar surface 504.

With this construction, the insert 120 may expand into the cutouts, including the cutouts 534 between the plate 350′ and the platform 334′ if excessive compression occurs, which avoids damaging the insert 120 and further maintains reliable retention and alignment of the insert 120 within the adapter 130′.

As shown in FIGS. 18 and 20, the second planar surface 510 abuts the first planar surface 504 along the lateral direction and the longitudinal direction. With reference to FIG. 20, the first channel 532, the second channel 540, and the cutouts 534 define a gap between the platform 334′ and the plate 350′ in the normal direction, the gap extending across the plate 350′ and the platform 334′ in the longitudinal direction.

FIG. 20 is a perspective view of the plate 350′ fixed with the platform 334′, where the plate 350′ and the platform 334′ are positioned and oriented for insertion into the first sleeve 300′. The platform 334′ and the first sleeve 300′ include an interlock 542 including tabs 544 and a groove 550 that selectively lock the first sleeve 300′ with the platform 334′.

The tabs 544 extend in the lateral direction from the platform 334′ toward the first sleeve 300′. The first sleeve 300′ defines the groove 550 with a rib 552, where the groove 550 is oriented to receive the tabs 544 and the rib 552 extends radially inward in the lateral direction from the first sleeve 300′ adjacent the groove 550. In assembly, the tabs 544 slide into the groove 550 through slots 554 defined in the rib 552 as the platform 334′ and the plate 350′ are inserted into the first sleeve 300′. In this regard, the rib 552 abuts the tabs 544 in a first rotational position about the longitudinal direction, locking the platform 334′ and the plate 350′ in the normal direction, the lateral direction, and the longitudinal direction relative to the first sleeve 300′. Rotating the platform 334′ and the plate 350′ to a second rotational position about the longitudinal direction allows the tabs 544 to pass the rib 552 through the slots 554, unlocking the first sleeve 300′ from the platform 334′ and permitting removal or repositioning relative to the platform 334′. While, as depicted, the platform 334′ includes the tabs 544 and the first sleeve 300′ defines the groove 550 and the rib, each of the platform 334′ and the first sleeve 300′ may additionally or alternatively include tabs, grooves, or ribs as portions of the interlock 542 without departing from the scope of the present disclosure.

Referring back to FIGS. 17 and 18, the second sleeve wall 360′ is cylindrical, and the platform 334′ includes a rounded surface 554 that is cylindrical and faces the second sleeve wall 360′ in the lateral direction and the normal direction. The platform 334′ contacts the second sleeve wall 360′ at a side of the platform 334′ opposite the first planar surface 504 in the normal direction. During assembly, the platform 334′ slides along the cylindrical wall of the second sleeve 302′ in both the longitudinal direction and a rotational direction orthogonal to the longitudinal direction. With this construction, a user may rotate the second sleeve 302′ relative to the first sleeve 300′ in threaded engagement without catching the platform 334′ or the plate 350′, and facilitates alignment of the platform 334′ and the plate 350′ within the adapter 130′.

The second sleeve 302′ houses the obstruction mechanism 332′ in the interior of the adapter 130′ with the first sleeve 300′, where the platform 334′ extends fully across the interior and contacts opposite sides of the second sleeve 302′ in the lateral direction. When the second sleeve 302′ is installed, the second sleeve 302′ abuts at least one of the platform 334′ and the plate 350′ in the longitudinal direction, securing a rotational position of the platform 334′ and the plate 350′ about the longitudinal direction relative to the second sleeve 302′. With this construction, the platform 334′ and the plate 350′ maintain alignment in the second sleeve 302′ during assembly and operation, and prevent the platform 334′ and the plate 350′ from rotating about the longitudinal direction when the adapter 130′ is assembled, thereby preventing the tab from rotating out of the groove during assembly and use.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Further, unless context suggest otherwise, descriptions of shapes (e.g., circular, rectangular, triangular, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

It will be appreciated that various embodiments of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. An isolator, comprising:
an isolator body including a distal isolator end portion that defines a first through hole extended toward a proximal isolator end portion in a longitudinal direction of the isolator body;
a grommet supported on the isolator body at the distal isolator end portion, wherein the grommet defines a second through hole that overlaps the first through hole in the longitudinal direction; and
a cap that engages the distal isolator end portion in the longitudinal direction, across the grommet, wherein the cap presses the grommet toward the isolator body, into the first through hole, reducing a width of the second through hole in a lateral direction orthogonal to the longitudinal direction.

2. The isolator of claim 1, wherein the cap includes a cap wall that defines a third through hole that overlaps the first through hole and the second through hole in the longitudinal direction, and includes a step that extends inward in the lateral direction from the cap wall, where the step reduces a width of the third through hole and presses the grommet toward the isolator body in the longitudinal direction.

3. The isolator of claim 2, wherein the cap includes a linear drive mechanism that converts a manually driven rotational motion into a linear motion of the cap in the longitudinal direction relative to the isolator body, pressing the grommet against the distal isolator end portion.

4. The isolator of claim 1, wherein the grommet is supported on the isolator body by a seat surface that is inclined inward along the longitudinal direction, where the seat surface reduces a width of the first through hole along the longitudinal direction from an exterior of the isolator body toward an interior of the isolator body, and the grommet slides across and compresses against the seat surface when the cap presses the grommet toward the isolator body.

5. The isolator of claim 4, wherein the distal isolator end portion forms a shoulder in the first through hole that extends inward in the lateral direction from the seat surface, and the first through hole is narrower than the second through hole at the shoulder.

6. An isolator, comprising:
an isolator body that defines a first through hole extended from a distal isolator end portion to a proximal isolator end portion in a longitudinal direction of the isolator body, wherein the isolator body includes a shed extended outward from the distal isolator end portion or the proximal isolator end portion in a lateral direction orthogonal to the longitudinal direction, and includes a seat surface disposed around the first through hole; and
a grommet inserted in the first through hole, wherein the grommet defines a second through hole in the isolator body, and pressing the grommet into the first through hole against the seat surface in the longitudinal direction reduces a width of the second through hole in a lateral direction orthogonal to the longitudinal direction.

7. The isolator of claim 6, wherein the grommet is shaped as a truncated cone extending along a longitudinal axis, the grommet is radially symmetric about the longitudinal axis, and the grommet defines the second through hole as a straight cylindrical through hole concentric with the longitudinal axis.

8. The isolator of claim 6, wherein the grommet includes a proximal grommet end portion and a distal grommet end portion opposite the distal grommet end portion, the proximal grommet end portion is positioned closer to an exterior surface of the distal isolator end portion at the first through hole in the longitudinal direction as compared to the distal grommet end portion, the distal grommet end portion is wider than the proximal grommet end portion in the lateral direction, and each of the distal grommet end portion and the proximal grommet end portion contact the seat surface.

9. The isolator of claim 8, wherein the seat surface is radially symmetric about the longitudinal direction, centered in the first through hole, and inclined flatly along the longitudinal direction,
an external surface of the grommet and the seat surface have a matching angular offset from the longitudinal direction, and
the grommet slides along the seat surface when inserted in the first through hole, where the isolator body compresses the grommet in the lateral direction.

10. A cable assembly including the isolator of claim 6, further comprising:
a cable including a jacket, a conductor extended through the jacket, and an insert extended through the jacket, wherein the jacket is sealed against the grommet at the second through hole, or wherein the distal isolator end portion forms a shoulder in the first through hole and the jacket abuts the shoulder in the longitudinal direction; and
an adapter fixed with the proximal isolator end portion, the adapter including an obstruction mechanism that retains the insert in an interior of the adapter, wherein the conductor passes the obstruction mechanism in the longitudinal direction.

11. An adapter comprising:
a sleeve including a wall that defines an interior in a lateral direction and a normal direction orthogonal to the lateral direction;
a platform disposed within the interior, extended in the lateral direction, and extended in a longitudinal direction orthogonal to the lateral direction and the normal direction;
a plate extended in the longitudinal direction and the lateral direction, wherein the plate is disposed in the interior and overlaps the platform in the normal direction; and
a fastener that fixes the plate with the platform, wherein the fastener continuously presses the plate toward the platform in the normal direction.

12. The adapter of claim 11, wherein the platform or the plate includes a planar surface that extends in the lateral direction and the longitudinal direction, and defines a channel in the planar surface extended along the longitudinal direction.

13. The adapter of claim 12, wherein the platform defines the channel located closer to a central longitudinal axis of the sleeve as compared to the wall in the lateral direction or the normal direction, and the adapter further comprises a rail extended from the channel toward the wall, the rail being inclined from the channel in the lateral direction and the normal direction, and extended beyond the planar surface in the normal direction.

14. The adapter of claim 12, wherein the platform defines a first channel, and the plate defines a second channel aligned with the first channel in the lateral direction, and oriented opposite the first channel in the normal direction.

15. The adapter of claim 12, wherein the platform or the plate also defines a cutout in the planar surface, the cutout extends directly from the channel in the lateral direction, and the cutout extends along the channel in the longitudinal direction.

16. The adapter of claim 12, wherein the platform extends across the interior and contacts opposite sides of the second sleeve in the lateral direction, or
wherein the wall is cylindrical, a surface of the platform facing the wall in the lateral direction and the normal direction is rounded about the longitudinal direction, abuts the wall in the lateral direction or the normal direction, and slides along the wall in the longitudinal direction and a rotational direction orthogonal to the longitudinal direction.

17. The adapter of claim 12, further comprising:
a tab extended in the lateral direction from one of the platform and the sleeve; and
a rib extended from the other of the platform and the sleeve extended perpendicular to the longitudinal direction,
wherein the rib abuts the tab when the sleeve is in a first rotational position about the longitudinal direction, and the tab passes the rib when the sleeve is in a second rotational position about the longitudinal direction.

18. The adapter of claim 12, wherein the sleeve is a first sleeve,
the adapter further comprises a second sleeve that engages the first sleeve, defines the interior continuously with the first sleeve in the lateral direction and the normal direction, and abuts the platform or the plate at a side of the platform or the plate opposite the first sleeve in the longitudinal direction,
the platform and the plate are disposed in the interior at the second sleeve, and the platform or the interior are wider than the interior at the first sleeve in the lateral direction.

19. A cable assembly including the adapter of claim 12, further comprising a cable that includes a conductor and an insert that extend through the sleeve in the longitudinal direction, wherein the conductor passes the platform and the plate in the longitudinal direction at a side of the plate opposite the platform in the normal direction, and the insert is interposed between the platform and the plate in the normal direction.

20. A cable assembly including the adapter of claim 12, further comprising:
an isolator body that defines a first through hole extended from a distal isolator end portion to a proximal isolator end portion in a longitudinal direction of the isolator body;
a grommet inserted in the first through hole, wherein the grommet defines a second through hole in the isolator body, and pressing the grommet into the first through hole against the seat surface in the longitudinal direction reduces a width of the second through hole in a lateral direction orthogonal to the longitudinal direction; and
a cable that includes a conductor and an insert extended through a jacket, wherein the jacket is sealed against the grommet at the second through hole, or wherein the distal isolator end portion forms a shoulder in the first through hole and the jacket abuts the shoulder in the longitudinal direction, and
wherein the adapter retains the insert in the interior between the platform and the plate, and the conductor passes the platform and the plate in the longitudinal direction.
